(19) United States
(12) Patent Application Publication
(10) Pub. No.: US 2024/0315403 A1
(43) Pub. Date: Sep. 26, 2024

(54) SLIDE FASTENER

(71) Applicant: Opti Germany GmbH, Rhauderfehn (DE)

(72) Inventors: Udo WADEN, Ostrhauderfehn (DE); Dirk EWEN, Rhauderfehn (DE); Marco AMMERMANN, Ostrhauderfehn (DE)

(21) Appl. No.: 18/615,577

(22) Filed: Mar. 25, 2024

(30) Foreign Application Priority Data
Mar. 23, 2023 (DE) 102023107295.1
Mar. 23, 2023 (DE) 202023101458.5

(51) Int. Cl. A44B 19/34; A44B 19/26; B60N 2/58

(52) U.S. Cl. CPC A44B 19/34; A44B 19/26; B60N 2/5816

(57) ABSTRACT

A slide fastener has a pair of stringer tapes and coupling members each fastened to the stringer tapes in a row. The rows of coupling members lie opposite one another and connect the two stringer tapes to one another in an interlocking manner. Each stringer tape is formed from two stringer tape portions, the coupling members each rest against a first stringer tape portion, and a second stringer tape portion is arranged on the side of the first stringer tape portion facing away from the coupling members. The first stringer tape portion and second stringer tape portion of stringer tapes are bent and connected to each other at a stringer tape region. A slider is designed such that a movement of the slider in a first direction connects the coupling members of the stringer tapes in an interlocking manner and releases them in an opposite direction.

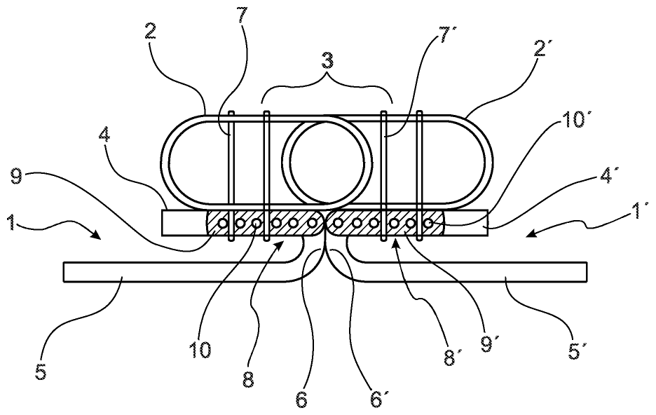

### BACKGROUND OF THE INVENTION

The invention relates to a slide fastener having a pair of stringer tapes arranged parallel to one another and coupling members each fastened to the stringer tapes in a row, wherein the rows of coupling members lie opposite one another and connect the two stringer tapes to one another in an interlocking manner, each stringer tape is formed from two stringer tape portions which are layered on top of one another, the coupling members each rest against a first stringer tape portion, and a second stringer tape portion is arranged on the side of the first stringer tape portion facing away from the coupling members, and the first stringer tape portion and the second stringer tape portion of both stringer tapes are bent and connected to one another at a stringer tape region facing the other stringer tape in each case, and having a slider which is guided along the rows by the coupling members, wherein the slider is designed such that a movement of the slider in a first direction connects the coupling members of the stringer tapes in an interlocking manner and releases them from one another in a second, opposite direction.

Hidden or seam-concealed slide fasteners are used, among other things, to attach fabric covers of objects, such as furniture or seat covers of motor vehicles, to them in such a manner that only a seam or a seam-like indentation of the fabric cover is visible. Due to the fact that in most cases the fabric covers in question are not intended and designed to be removed again and remain in their intended position permanently or for a longer period of time, they are usually fitted on extremely tightly, so that relatively large tensile forces act on the hidden slide fastener. These tensile forces can then lead to the fact that the slide fastener, which is actually hidden as a seam, is visible during normal use.

The object of the invention is therefore to provide such a hidden or seam-concealed slide fastener which is further developed in such a manner that it is completely concealed by the fabric cover even under corresponding tensile load.

### SUMMARY OF THE INVENTION

This object is achieved by a slide fastener according to the features of claim 1. Further embodiments and advantageous configurations of the slide fastener are specified in the subordinate claims.

The slide fastener, having a pair of stringer tapes arranged parallel to one another and coupling members each fastened in a row to the stringer tapes, wherein the rows of coupling members lie opposite one another and connect the two stringer tapes to one another in an interlocking manner, each stringer tape is formed from two stringer tape portions which are layered on top of one another, the coupling members each rests against a first stringer tape portion, and a second stringer tape portion is arranged on the side of the first stringer tape portion facing away from the coupling members, and the first stringer tape portion and the second stringer tape portion of both stringer tapes are bent and connected to one another at a stringer tape region facing the other stringer tape in each case, and having a slider which is guided along the rows by the coupling members, in particular the coupling members of both stringer tapes, wherein the slider is designed such that a movement of the slider in a first direction connects the coupling members of the stringer tapes in an interlocking manner and releases them from one another in a second, opposite direction, is characterized according to the invention in that at least the first stringer tape portions of the stringer tapes have a stiffened region which extends into the bent stringer tape region, and in that the stringer tapes forming a pair abut against the bent stringer tape regions when the coupling members interlock.

The additional stiffening has the effect that the two stringer tapes and thus also each of the sides of the seat or fabric cover to be connected to the second stringer tape portions of the stringer tapes as intended are pressed against each other and thus also abut against one another under counteracting tensile load. Only the seam imitation can then be seen at the joint of the fabric covers.

In a further configuration, the stringer tapes are formed from woven material with warp threads oriented parallel to the rows of coupling members. Accordingly, the fabrics are based on known structures so that the production thereof can be implemented relatively easily in known production processes.

According to a further development of the invention, the stringer tapes have warp threads made of two-component yarn, in particular polyester two-component yarn, in the stiffened region. These two-component yarns are formed from a core yarn coated with a melt layer. Together with at least one weft thread and further warp threads adjoining the region with warp threads from the two-component yarn, the core thread of the two-component yarn then forms the fabric which forms the basic structure of the stringer tapes. In particular, the second stringer tape portion of the stringer tapes is formed from unsheathed warp threads. In addition, an end region of the first stringer tape portion facing away from the bent stringer tape region can preferably be formed from unsheathed warp threads.

In a further configuration, the stiffened region has at least five warp threads made of two-component yarn, in particular between 5 and 9 warp threads, in particular between 6 and 8 warp threads. These warp threads made of the two-component yarn are preferably arranged next to each other in the fabric of the stringer tapes of the slide fastener and provide sufficient stiffening of the stringer tapes to counteract the tensile forces acting on them as intended.

According to a further development, each of the stringer tapes has only a single stiffened region made of two-component yarn. This region is preferably adapted to the intended use, so that the slide fastener meets the highest requirements for flame retardancy and fire protection.

Finally, the stiffening is achieved in that the two-component yarn forms a plastic layer in the stiffened region, in particular a thermoset or thermoplastic, which is cured after heating, having an enclosed core yarn. The thermoset then forms a permanent, irreversible stiffening of the region into which the two-component yarn is inserted, even if the aforementioned tensile forces act thereon, for example in the case of seat covers or furniture. In addition to a two-component yarn that forms a thermoset, it is also possible, as an alternative, to use a two-component yarn that forms a thermoplastic after heating, wherein the application temperature of the slide fastener in use must then be below the melting temperature of the thermoplastic in order to ensure that the slide fastener cured after heating retains its shape permanently. A characteristic feature of both the thermoset and the thermoplastic is the continuous, stiffening plastic layer with an enclosed core thread, which forms the stringer tape at least in sections.

The row of coupling members of a stringer tape can also form a helix and the stiffened region of a stringer tape with interlocking coupling members can extend over at least half of a helix width of the slide fastener formed by the two helixes of the rows of coupling members. The stiffening plastic layer is aligned with the coupling members in such a manner that the plastic layers of the stringer tapes forming a slide fastener extend over the entire length and width of the helix width or spiral width or also toothing and abut against one another in the region of the helix width in the case of interlocking coupling members. The stiffened regions formed by the plastic layers can also abut eccentrically in the case of interlocking coupling members, so that the stiffened region of one stringer tape overlaps the coupling members of the other stringer tape.

In order to achieve additional or stronger stiffening, according to another further development, it is provided that the stringer tapes have a weft thread made of two-component yarn, in particular polyester two-component yarn. The weft thread running transverse to the warp threads extends over the entire width of the stringer tape, in particular the entire width of the stringer tape consisting of the first and second stringer tape portions with the bent stringer tape region connecting them. According to this design, the region in which the weft thread and warp threads cross is stiffened more than the regions reinforced only with the weft thread.

Due to the fact that additional warp threads made of two-component yarn are incorporated outside the stiffened region, it is also possible to create regions with different levels of reinforcement if required by the application.

In order to ensure the simplest possible production of the stringer tapes, according to another further development, it is provided that the stringer tapes are formed from single-layer fabric. Special applications that require differentiation of the stringer tapes into differently stiffened regions can alternatively have stringer tapes made of multi-layer fabric, wherein the two-component yarn is incorporated into at least one layer of the fabric, in particular incorporated into at least two layers of the fabric, in particular incorporated into all layers of the fabric. The warp threads of two-component yarn are then distributed according to a respective requirement, wherein higher overall stiffnesses can be achieved by warp threads of two-component yarn arranged in multiple layers between which a common plastic layer is formed.

The invention also relates to a seat cover for a motor vehicle seat, wherein the seat cover is intended and designed to be pulled from above onto the previously coverless motor vehicle seat during the production process and wherein the motor vehicle seat has at least one slide fastener running substantially vertically. According to the invention, this seat cover is characterized in that the slide fastener is designed in accordance with the aforementioned features. The slide fastener, as intended, can imitate a seam and is thus completely concealed.

An exemplary embodiment of the invention, from which further features pertinent to the invention can arise, is shown in the drawing.

### BRIEF DESCRIPTION OF THE DRAWINGS

The sole FIGURE in the drawing shows a cross-section of a slide fastener according to the invention

### DETAILED DESCRIPTION OF THE INVENTION

The figure in the drawing shows a cross-section of a slide fastener according to the invention with two stringer tapes 1, 1′ arranged in pairs, and rows of coupling members 2, 2′ which are held in each case on the stringer tapes 1, 1′ and are connected to one another in an interlocking manner and define a helix width 3 of the slide fastener. The stringer tapes 1, 1′ each have a first stringer tape portion 4, 4′ and a second stringer tape portion 5, 5′, which rest against each other for each stringer tape 1, 1′ and are connected to one another via a respective bent stringer tape region 6, 6′. Furthermore, the stringer tapes 1, 1′ are each connected to the coupling members 2, 2′ via the first stringer tape portion 4, 4′ in that the coupling members 2, 2′ and first stringer tape portions 4, 4′ are connected by means of sewing threads 7, 7′. The second stringer tape portions 5, 5′ are each used as intended to be connected to a seat cover not shown in the drawing.

The stringer tapes 1, 1′ each have a stiffened region 8, 8′ which extends over a partial region of the first stringer tape portion 4, 4′ up to the bent stringer tape region 6, 6′. The stiffened regions 8, 8′ are each formed by plastic layers 9, 9′ which are formed from melt layers of two-component yarns incorporated in the stiffened region 8, 8′. Within the plastic layers 9, 9′, core yarns 10, 10′ corresponding to the number of two-component yarns are also visible. The stiffened regions 8, 8′ effect that the stringer tapes 1, 1′ each protrude into the region of the coupling members 2, 2′ defined as the helix width 3 and abut against the bent stringer tape regions 6, 6′.

1. A slide fastener, having a pair of stringer tapes arranged parallel to one another and coupling members each fastened in a row to the stringer tapes, wherein the rows of the coupling members lie opposite one another and connect the two stringer tapes to one another in an interlocking manner, each stringer tape is formed from two stringer tape portions which are layered on top of one another, the coupling members each rests against a first stringer tape portion, and a second stringer tape portion is arranged on the side of the first stringer tape portion facing away from the coupling members, and the first stringer tape portion and the second stringer tape portion of both stringer tapes are bent and connected to one another at a stringer tape region facing the other stringer tape in each case, and having a slider which is guided along the rows by the coupling members, wherein the slider is designed such that a movement of the slider in a first direction connects the coupling members of the stringer tapes in an interlocking manner and releases them from one another in a second, opposite direction,
wherein at least the first stringer tape portions of the stringer tapes have a stiffened region which extends into the bent stringer tape region, and
wherein the stringer tapes forming a pair abut against the bent stringer tape regions when the coupling members interlock.

2. The slide fastener according to claim 1, wherein the stringer tapes are formed from woven material with warp threads oriented parallel to the rows of coupling members.

3. The slide fastener according to claim 1, wherein the stringer tapes in the stiffened region have warp threads made of two-component yarn, in particular polyester two-component yarn.

4. The slide fastener according to claim 1, wherein the stiffened region has at least five warp threads made of two-component yarn, in particular between 5 and 9 warp threads, in particular between 6 and 8 warp threads.

5. The slide fastener according to claim 1, wherein the stringer tapes each form a single stiffened region.

6. The slide fastener according to claim 3, wherein the two-component yarn in the stiffened region forms a plastic layer, in particular a thermoset or a thermoplastic, which is cured after heating, having an enclosed core yarn of the two-component yarn.

7. The slide fastener according to claim 1, wherein the coupling members of a stringer tape form a helix and the stiffened region of a stringer tape extends over at least half of a helix width of the slide fastener formed by the two helixes when the coupling members interlock.

8. The slide fastener according to claim 1, wherein the stringer tapes have a weft yarn made of two-component yarn, in particular polyester two-component yarn.

9. The slide fastener according to claim 1, wherein the stringer tapes are formed from single-layer fabric.

10. The slide fastener according to claim 1, wherein the stringer tapes are formed from multi-layer fabric, wherein the two-component yarn is incorporated into at least one layer of the fabric, in particular incorporated into at least two layers of the fabric, in particular incorporated into all layers of the fabric.

11. A seat cover for a motor vehicle seat, wherein the seat cover is intended and designed to be pulled from above onto the previously coverless motor vehicle seat during the production process and wherein the motor vehicle seat has at least one slide fastener running substantially vertically,
wherein the slide fastener is designed in accordance with the features of claim 1.
